(19) United States
(12) Patent Application Publication
(10) Pub. No.: US 2015/0064684 A1
(43) Pub. Date: Mar. 5, 2015

(54) ASSESSMENT OF CURATED CONTENT

(71) Applicant: FUJITSU LIMITED, Kawasaki-shi (JP)

(72) Inventors: Takuro WATANABE, Santa Clara, CA (US); Kanji UCHINO, San Jose, CA (US); Yuko OKUBO, Berkeley, CA (US); Jun WANG, San Jose, CA (US)

(73) Assignee: FUJITSU LIMITED, Kawasaki-shi (JP)

(21) Appl. No.: 14/013,139

(22) Filed: Aug. 29, 2013

(51) Int. Cl. G09B 5/06

(52) U.S. Cl. CPC G09B 5/06
USPC 434/367

(57) ABSTRACT

A method of assessing curated content may include receiving curated content. The method may also include assessing a quality of the curated content based on a predefined quality criteria and a selected template. The method may further include measuring user engagement with the curated content based on a predefined user engagement criteria. The method may also include generating a quality assessment result and a user engagement assessment result based on the assessed quality of the curated content and the measured user engagement of the curated content.

### FIELD

The embodiments discussed herein are related to assessment of curated content.

### BACKGROUND

Curations may include a list of items, such as digital files, that are organized by the curator. Curations may combine various forms of content. For example, curations may include digital files generated by the curator with web content accessed via a network such as the internet. Additionally, curations may include modifications to web content by the curator. The items in the curations may be organized according to topic or theme. In curation learning, for instance, the items in the curation may be organized according to a topic or theme of an assignment issued by a teacher. The teacher may wish to assess curations created in response to the assignment. However, due to the size and complexity of curations, assessment of curations may be relatively difficult and time consuming.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of an embodiment, a method of assessing curated content may include receiving curated content. The method may also include assessing a quality of the curated content based on a predefined quality criteria and a selected template. The method may further include measuring user engagement with the curated content based on a predefined user engagement criteria. The method may also include generating a quality assessment result and a user engagement assessment result based on the assessed quality of the curated content and the measured user engagement of the curated content.

The object and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 is a block diagram of an example operating environment in which some embodiments may be implemented;

FIG. 2 illustrates a block diagram depicting an example curated content assessment system that may be included in the operating environment of FIG. 1 in communication with a teacher;

FIG. 3 illustrates a block diagram of the curated content assessment system of FIG. 2 assessing an example curation;

FIG. 4 illustrates an example quality assessment result and an example user engagement assessment result that may result from the assessment depicted in FIG. 3; and

FIG. 5 is a flow diagram of an example method of assessing curated content, all in accordance with at least one embodiment described herein.

### DESCRIPTION OF EMBODIMENTS

Some embodiments discussed herein are related to assessment of curated content. In an example embodiment, an assessment system may be configured to assess curated content based on predefined criteria and a selected template. The curated content may include manuscripts generated by a curator; web content, which may be accessed via a network and included in the curated content; and edits to the web content by the curator.

The curated content may be generated in response to an assignment issued by a teacher. The teacher may additionally communicate teaching materials to the assessment system. The assessment system may receive the teaching materials and other input from the teacher that enable formulation of the selected template by which the curated content may be assessed. The assessment system may additionally include one or more predefined criteria by which quality of the curated content and user engagement with the curated content is assessed. The assessment system may generate a quality assessment result and a user engagement assessment result based on the assessment of the curated content.

Embodiments of the present invention will be explained with reference to the accompanying drawings.

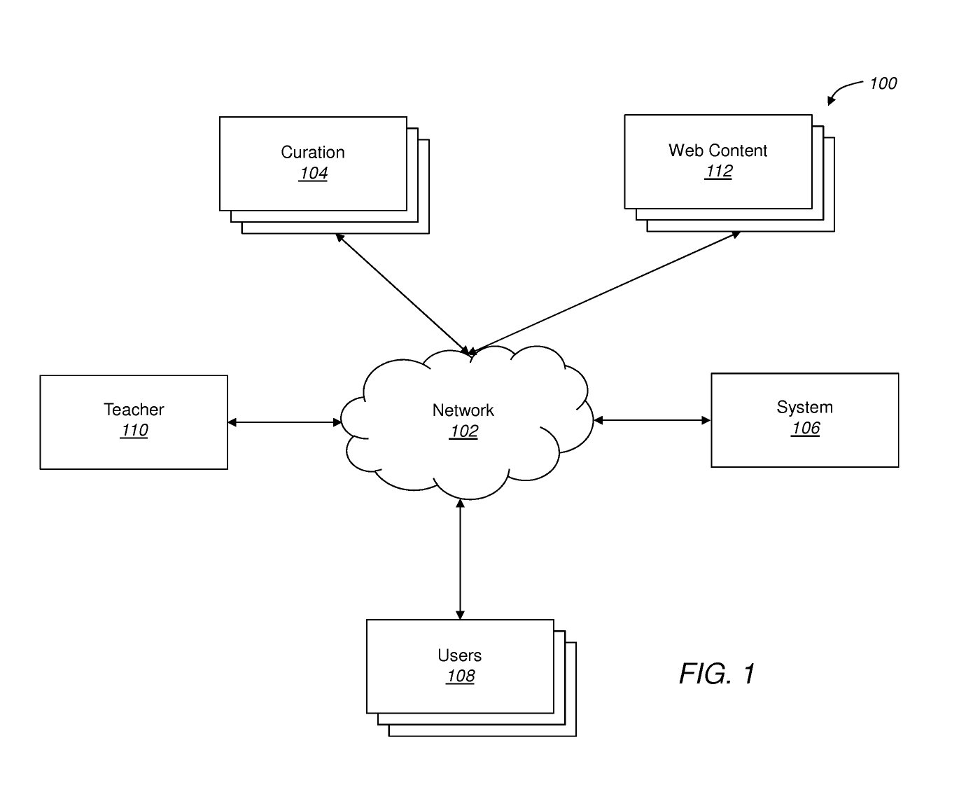

FIG. 1 is a block diagram of an example operating environment 100 in which at least one embodiment may be implemented. The operating environment 100 may include a network 102, curations 104, a curated content assessment system (hereinafter “system”) 106, one or more end users (hereinafter “user” or “users”) 108, a teacher 110, and web content 112.

In general, the network 102 may include one or more wide area networks (WANs) and/or local area networks (LANs) that enable communication between the system 106, the users 108, and the teacher 110. Additionally, the network may enable the system 106, the users 108, and the teacher 110 to access the curations 104 and/or the web content 112. In some embodiments, the network 102 includes the Internet, including a global internetwork formed by logical and physical connections between multiple WANs and/or LANs. Alternately or additionally, the network 102 may include one or more cellular RF networks and/or one or more wired and/or wireless networks such as, but not limited to, 802.xx networks, Bluetooth access points, wireless access points, IP-based networks, or the like. The network 102 may also include servers that enable one type of network to interface with another type of network.

As used herein, a “curation” (e.g., the curation 104) may include a list of items, such as digital files, which are organized and/or edited by an entity referred to as a “curator.” In the operating environment 100, one or more of the user 108 may be curators. The items included in the curation 104 may include items that are accessed via the network 102, which are referred to herein as the web content 112, as well as items generated by the curator. Additionally, in some curations 104, the web content 112 included in the curations 104 may be edited by the curator when included in the curation 104. The set of items and/or edits to the set of items that may be included in any of the curations 104 are referred to herein as curated content.

For example, the curated content may include a digital manuscript generated by the user 108, which may be a curator, as well as an article authored by another entity, published in an online newspaper, and accessed via the network 102. The user 108, who may be the curator or another user, may edit or comment on the article while it is included in the curation 104. Each of the digital manuscript, the article, and the edits or comments may be included in the curated content. Some additional examples of web content or user-generated content may include, but are not limited to, web pages, audio files, video files, electronic documents, and virtually any other digital files or content.

The curations 104 or some portion thereof may be accessible on websites hosted by one or more corresponding web servers communicatively coupled to the Internet, for example. The accessibility of the curations 104 may enable other users 108 and/or the teacher 110 to comment on the curation 104 and may enable a curator to view and/or reply to the comments. Additionally, the accessibility of the curations 104 may enable the system 106 to access and/or assess the curations 104 and the curated content included therein.

In the operating environment 100, the users 108 include people and/or other entities that create and/or view the curations 104, and thus the users 108 may include curators. At least some portion of the users 108 may include students who are creating the curations 104 in response to an assignment issued by the teacher 110. The users 108 may create the curations 104 pertaining to the assignment by generating one or more items (e.g., authoring a manuscript) and/or accessing web content 112 to include as items in the curation 104.

The system 106 may provide an automatic or substantially automatic assessment of the curations 104. For example, after a deadline associated with an assignment for students to create curations has passed, the system may assess the curations 104. Additionally or alternatively, following the creation of the curation 104, one or more other users 108 may access the curations 104 and comment on the curations 104.

Although not separately illustrated, one or more of the users 108 and the teacher 110 may communicate with the network 102 using a corresponding computing device. The computing devices may include, but are not limited to, a desktop computer, a laptop computer, a tablet computer, a mobile phone, a smartphone, a personal digital assistant (PDA), or other suitable computing device.

Although details are provided with respect to the operating environment 100 that include the teacher 110 and the users 108, a portion of which may include students; some alternative embodiments may be implemented in one or more similar operating environments. For example, rather than the teacher 110 and the users 108, an alternative operating environment may include a supervisor and employees, a governmental institution and enterprises, a first department of an enterprise and multiple other departments of the enterprise, or any other suitably related entities.

To formulate a template by which the curations 104 are assessed, the system 106 may communicate with the teacher 110. Additionally or alternatively, the system 106 may have one or more criteria that are predefined or partially predefined by a system administrator, technical staff, etc.

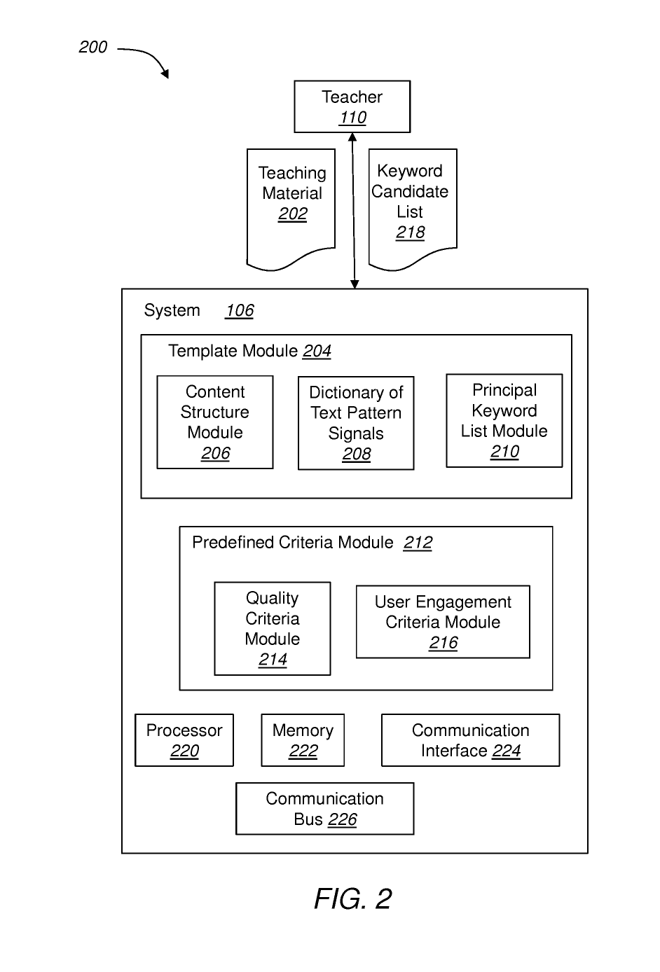

FIG. 2 illustrates a block diagram 200 depicting an example embodiment of the system 106 of FIG. 1 in communication with the teacher 110 of FIG. 1. The block diagram 200 illustrates some details of the system 106 and some example communications between the system 106 and the teacher 110, which communications may be used to formulate some details of the template by which curated content is assessed.

As illustrated, the system 106 includes a processor 220, a communication interface 224, and a memory 222. The processor 220, the communication interface 224, and the memory 222 may be communicatively coupled via a communication bus 226. The communication bus 226 may include, but is not limited to, a memory bus, a storage interface bus, a bus/interface controller, an interface bus, or the like or any combination thereof.

In general, the communication interface 224 may facilitate communications over a network, such as the network 102 of FIG. 1. The communication interface 224 may include, but is not limited to, a network interface card, a network adapter, a LAN adapter, or other suitable communication interface.

The processor 220 may be configured to execute computer instructions that cause the system 106 to perform the functions and operations described herein. The processor 220 may include, but is not limited to, a processor, a microprocessor (μP), a controller, a microcontroller (μC), a central processing unit (CPU), a digital signal processor (DSP), any combination thereof, or other suitable processor.

Computer instructions may be loaded into the memory 222 for execution by the processor 220. For example, the computer instructions may be in the form of one or more modules, such as, but not limited to, a template module 204, a predefined criteria module 212, a content structure module 206, a principal keyword list module 210, a dictionary of text pattern signals 208, a quality criteria module 214, and a user engagement criteria module 216.

In some embodiments, data generated, received, and/or operated on during performance of the functions and operations described herein may be at least temporarily stored in the memory 222. Moreover, the memory 222 may include volatile storage such as RAM. More generally, the system 106 may include a non-transitory computer-readable medium such as, but not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory computer-readable medium.

In the example system 106 depicted in FIG. 2, curated content may be assessed based on predefined criteria and a selected template. The predefined criteria may be defined, stored in, and otherwise controlled by the predefined criteria module 212. To define the criteria included in the predefined criteria module 212, an entity such as the teacher 110 and/or an administrator may program one or more criteria into the predefined criteria module 212, for instance.

The predefined criteria may include a predefined quality criteria (quality criteria) and a predefined user engagement criteria (engagement criteria). The quality criteria may be used to assess the quality of items included in the curated content. The quality of the items may be assessed individually and in relation to one another. The engagement criteria may be used to measure user engagement with the curated content. Accordingly, the predefined criteria module 212 may include the quality criteria module 214 and the user engagement criteria module 216.

As mentioned above, the quality criteria and the engagement criteria may be programmed by an entity. Additionally, the quality criteria and the engagement criteria may be updated and modified. In some embodiments, the quality criteria may include, but are not limited to, whether the curated content meets a condition of the selected template (discussed below); whether items of the curated content pertain to a particular topic; a source quality of items of the curated content; a quantity of curator-generated content included in the curated content; a number of comments associated with the curated content; and a number of views of the curated content. These quality criteria are meant as a non-limiting, illustrative list of quality criteria. Implementation of some of these quality criteria is discussed below.

The selected template may be at least partially defined through communication with the teacher 110. In this and other embodiments, the selected template may include a content structure and a principal keyword list. The content structure may be defined, stored in, or otherwise controlled by the content structure module 206. Similarly, the principal keyword list may be defined, stored in, or otherwise controlled by the principal keyword list module 210.

The content structure may generally include the type or nature of curated content. For example, in the operating environment 100 of FIG. 1, an assignment issued by the teacher 110 may indicate the type of curations to be created in response to the assignment, and may therefore indicate the content structure. Some example content structures may include an event structure, an enumeration structure, a description structure, a definition structure, a sequence structure, a process structure, a time order structure, a chronology structure, a compare-contrast structure, a proposition support structure, a judgment structure, a critique structure, a cause-effect structure, a problem-solution structure, no structure, which is also referred to as empty, or any combination thereof. For instance, the assignment may be to create a curation concerning the history of World War I. The content structure may accordingly include a chronology structure.

The content structure may be indicated by a text pattern signal. The text pattern signal may include a set of words and phrases that may be embedded in a specific kind of structure indicative of the content structure. In the World War I example above, the text pattern signal may include one or more of the words and phrases “afterwards,” “as,” “before,” “initially,” “later on,” “meanwhile,” “much later,” etc. Other content structures may include text patterns that indicate the corresponding content structure. Some example text pattern signals may include, but are not limited to, an event text pattern signal; a sequence text pattern signal; a chronology text pattern signal; a compare-contrast text pattern signal; a problem-solution text pattern signal; and an empty text pattern signal. Each text pattern signal may include a set of words and phrases that indicate the corresponding content structure. In some circumstances, multiple text pattern signals may share words and phrases.

In the system 106, the text pattern signals may be defined in the dictionary of text pattern signals (dictionary) 208. The dictionary 208 may include an initial set of words and phrases or may enable the teacher 110 or another entity to select one or more of the initial words and phrases to include in a text pattern signal. To assess the content structure of the curated content, the system 106 may calculate a hit ratio between words and phrases included in the text pattern signal and terms included in the curated content.

In some embodiments, the teacher 110 or another entity may select the content structure. For example, the teacher 110 may communicate a selected content structure type to the content structure module 206. Additionally or alternatively, the teacher 110 or another entity may select one or more words and phrases to include in the dictionary 208 for a text pattern signal corresponding to a content structure.

The selected template may also include the principal keyword list. In this and other embodiments, the principal keyword list may be generated through one or more communications with the teacher 110. For example, the teacher 110 may communicate a teaching material 202 such as a syllabus or another educational material to a principal keyword list module 210. The principal keyword list module 210 or another portion of the system 106 may parse the teaching material 202 to generate a keyword candidate list 218. Keywords included in the keyword candidate list 218 may include words or phrases from the teaching material 202 that occur multiple times, are included in the title, are included in highlighted sections, or the like.

The keyword candidate list 218 may be communicated to the teacher 110. The teacher 110 may then select keywords from the keyword candidate list 218 or otherwise provide input effective to select keywords from the keyword candidate list. The selected keywords may be communicated to the system 106 where the selected keywords may be included in the principal keyword list.

In sum, the template module 204 may include a selected template. The selected template may further include words and phrases selected in the dictionary 208 that indicate a content structure. Additionally, the selected template may include a principal keyword list that includes multiple keywords. The assessment of curated content may accordingly include evaluating the presence, or lack thereof, of the words and phrases from the content structure and/or the selected keywords in the principal keyword list.

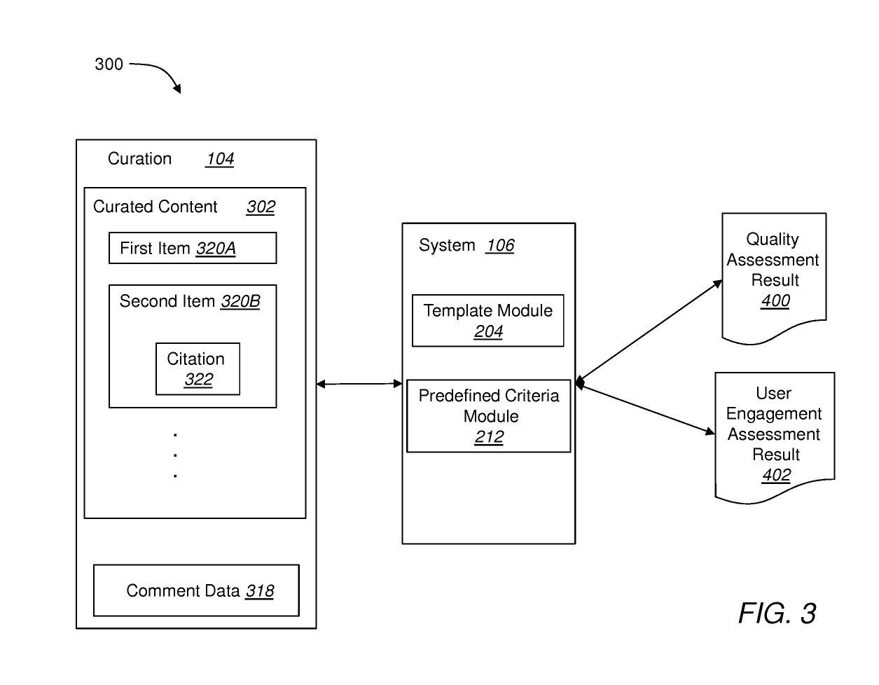

FIG. 3 illustrates a block diagram 300 of an example embodiment of the system 106 of FIGS. 1 and 2 assessing an example embodiment of the curation 104 of FIG. 1. The system 106 may receive the curation 104, may assess the curated content 302, and may generate a quality assessment result 400 and a user engagement assessment result 402.

In the illustrated embodiment, the curated content 302 of the curation 104 may include one or more items 320A and 320B (hereinafter “item 320” or “items 320”). Additionally, the curation 104 may include comment data 318. The comment data 318 may be included in the curation 104 as shown or may be otherwise associated with the curation 104 through a “comment” link, for instance.

To assess the curation 104, the system 106 may access the curation 104 via a network and/or the curations 104 may be communicated to the system 106 by a user or a teacher. When the curation 104 is received, the curation 104 may be assessed based upon predefined criteria in the predefined criteria module 212 and/or a selected template in the template module 204.

From the assessment, the system may generate a quality assessment result 400 and a user engagement assessment result 402. In general, the quality assessment result 400 may be generated based upon an assessment of the curated content 302 and/or the comment data 318 using a selected template (as described above) and quality criteria (also discussed above). The user engagement assessment result 402 may be generated based upon an assessment of the curated content 302 and/or the comment data 318 using the engagement criteria (also described above).

In this and other embodiments, the quality criteria may include whether the curated content meets one or more conditions of the selected template. As described above, the selected template may include a principal keyword list and a content structure. Each of the principal keyword list and the content structure includes a set of words (e.g., words and phrases in a dictionary of a text pattern signal and keywords in the principal keyword list). In assessing whether the curated content meets the conditions of the selected template, the system 106 may scan each item 320 in the curated content 302 and determine one or more hit counts between the terms in each of the items and those in the selected template. This quality criterion may be scored as a percentage (e.g., the curated content 302 includes 88% of the words in the selected template), a total number (e.g., the curated content 302 includes 150 of the words in the selected template), or scored in another suitable way.

Additionally or alternatively, the quality criteria may include whether items 320 of the curated content 302 pertain to a particular topic. To determine whether the items 320 pertain to a particular content, the system 106 may scan titles, text, captions, tags in photos, for instance, of the items 320. The system 106 may then check for relationships between terms used in the titles, text, etc. For example, a first item 320A may include an essay drafted by a curator about the causes of World War I. A second item 320B may include an article about World War I entitled “Armament—the Trigger of World War I.” The system 106 may scan the titles and text of the first and second items 320A and 320B and determine the first and second items 320A and 320B relate to causes of World War I.

A score for the pertinence of the items 320 to a particular topic may be quantified by a number of items 320 having a threshold relatedness or may be scored in another suitable way. For instance, the first item 320A and the second item 320B may be sufficiently related, which may result in a score of 100%. A source quality (discussed below) for each item 320 may be averaged or summed to obtain a total score for the pertinence of the items 320 to a particular topic.

Additionally or alternatively, the quality criteria may include a source quality of the items 320 of the curated content 302. The source quality of the items 320 may be related to and/or quantified by the reputation of a source, a popularity of a source, a number of times a source has been cited in other curations, etc. For example, in an embodiment in which the curated content 302 includes an article from a heavily cited (e.g., hundreds of citations) article, the source quality may be higher that an article with no citations. Alternatively, a system administrator may predetermine source quality. For example, the second item 320B may include a citation 322. The citation 322 may reference a piece of web content that may originate at a well-known or an established source that the system administrator had determined is reputable or reliable. The reputable or reliable source may receive a higher quality score than a source that the system administrator has determined is less reputable or less reliable.

A score for the source quality may include a decimal from zero to one (e.g., 0.6, 0.8, or 1). The source quality for each item 320 may be averaged or summed to obtain a total score for the source quality.

Additionally or alternatively, the quality criteria may include a quantity of curator-generated content included in the curated content 302. As discussed above, the curator-generated content may include comments, annotations, modifications to web content, and/or manuscripts, etc. authored by the curator. This quality criterion may be scored as a percentage (e.g., the curated content 302 includes 35% curator-generated content), a total number (e.g., the curated content 302 includes eleven paragraphs of curator-generated content), or scored in another suitable way.

To determine the quantity of curator-generated content included in the curated content 302, the system 106 may identify item types. In some embodiments, the system 106 may analyze metadata, media access control (MAC) addresses, etc. to determine whether an item 320 is curator-generated content. For example, if the first item 320A is a word processing document loaded from a computing device of a curator, then the system 106 may detect that the first item 320A is a word processing document and/or that the first item 320A was loaded from the computing device through analysis of the metadata associated with the word processing document.

Additionally, to determine the quantity of curator-generated content included in the curated content 302, the system 106 may identify differences between cited original content and the curated content, and then total a number of words edited from the cited original content or otherwise quantify the difference. For example, the citation 322 of the second item 320B may include a citation to original content, which was modified by the curator. The system 106 may access the original content via the network, for instance, and may compare the second item 320B as it appears in the curated content 302 with the original content.

Additionally or alternatively, the quality criteria may include a number of comments associated with the curated content 302. This quality criterion may include assessment of the comment data 318. For example, the system 106 may count or tally the number of comments included in the comment data 318 that are associated with the curated content 302. A score for the number of comments may include the total number of comments received that are associated with the curated content 302. In some embodiments, the number of comments may reflect positively on the curated content 302. For example, curated content 302 with a higher number of comments may score better than curated content 302 with a fewer number of comments.

Additionally or alternatively, the quality criteria may include a number of views of the curated content 302. The number of views generally refers to a number of users that viewed the curated content 302. The number of views may be determined by the system 106 through a communication with a server that hosts the curation 104, through reading data included in a hit counter, or the system 106 may count the number of views while monitoring the curated content 302. A score for the number of views may include the total number of views received by the curated content 302. In some embodiments, a higher number of views may reflect positively on the curated content 302.

Each score of the quality criteria may be averaged, may be combined with a weighting factor, or otherwise combined to generate the quality assessment result 400. Additionally, each of the scores may be individually presented. The quality criteria described herein are not meant to be limiting. In alternative embodiments, similar quality criteria may be implemented by the system 106 to assess the quality of the curated content 302.

In this and other embodiments, the engagement criteria may include whether another user who commented on the curated content 302 and/or the curator of the curated content 302 has commented on other content in a similar topic area. In this and other embodiments, the system 106 may identify the users from the comment data 318. The system 106 may then search for other comments on other web content, other curations, etc. made by the user and/or the curator. When the system 106 finds other comments by the user and/or the curator, the system 106 may determine the topic of the other content on which the user and/or the curator has commented. The system 106 may then score the user engagement based on the number of users who commented on the curated content 302 that also commented on other content in a similar topic area. Additionally or alternatively, the system 106 may score the user engagement based on the number comments posted by the curator on other content in a similar topic area. In some embodiments, having a large number of users who commented on the curated content 302 that also commented on other content in a similar topic area may be viewed favorably. Additionally or alternatively, having a large number of comments posted by the curator on other content in a similar topic area may be viewed favorably.

In this and other embodiments, the engagement criteria may include whether a curator of the curated content 302 replied to comments on the curated content 302. For example, the system 106 may scan the comment data 318 to determine a number of comments included therein that are posted by the curator of the curated content 302. Additionally, the system 106 may scan the text of the comments to determine the relatedness between comments posted by users and comments posted by the curator. The curated content may be scored according to a number of reply comments, by a percentage of comments to which the curator replied, or scored in another suitable way.

Each score of the engagement criteria may be averaged, may be combined with a weighting factor, or otherwise combined to generate the user engagement assessment result 402. Additionally, one or more of the scores may be individually presented. The engagement criteria described herein are not meant to be limiting. In alternative embodiments, other engagement criteria may be implemented by the system 106 to assess the user engagement of the curated content 302, or assessment of the user engagement may not occur.

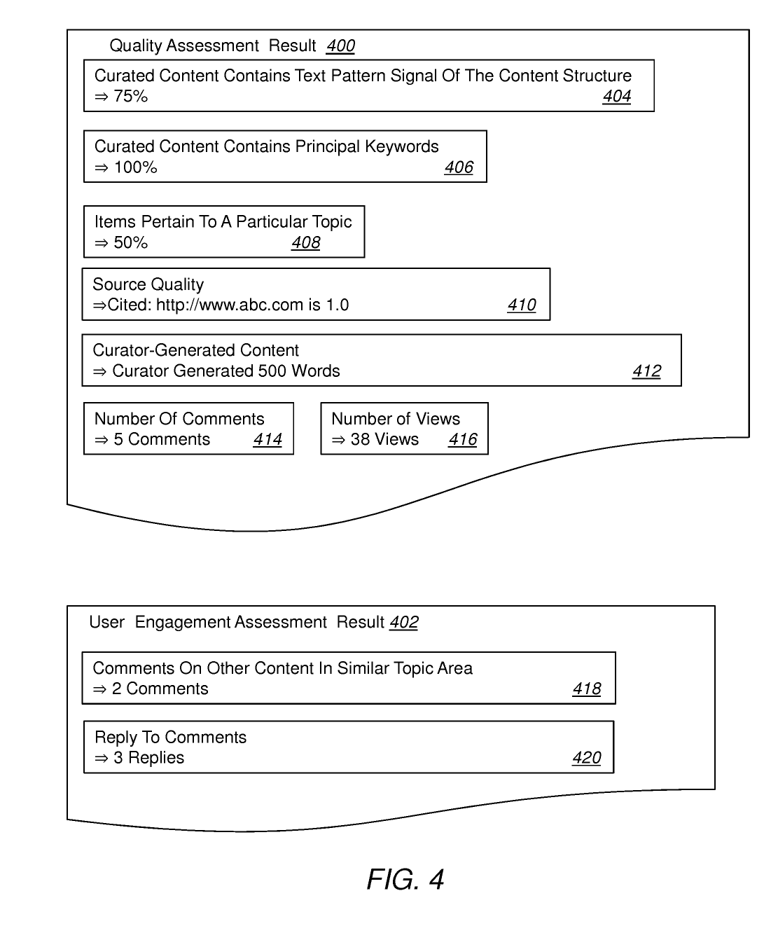

FIG. 4 illustrates an example embodiment of the quality assessment result 400 and an example embodiment of the user engagement assessment result 402 of FIG. 3. The quality assessment result 400 and the user engagement assessment result 402 may generally result from an assessment of curated content such as that depicted in and/or described with respect to FIG. 3. The quality assessment result 400 and the user engagement assessment result 402 may be physical documents such as word processing documents, may be a set of digital data, or may be included in larger collections of digital data. The quality assessment result 400 and the user engagement assessment result 402 may include scores for one or more of the criteria included in a predefined criteria and/or a selected template.

In this and other embodiments, the quality assessment result 400 includes a set of scores 404, 406, 408, 410, 412, 414, and 416 that may result from an assessment of curated content and/or comment data of a curation. A first score 404, which is depicted as a percentage, may indicate a hit ratio between the text pattern signal of the content structure and the curated content. In the depicted embodiment, 75% of the words and phrases in the text pattern signal of the content structure are contained in an assessed curated content. Thus, the first score is 75%. A second score 406 may include a percentage of a number of principal keywords contained in the curated content. In the depicted embodiment, 100% of the principal keywords are contained in the curated content. Thus, the second score 406 is 100%. A third score 408 may include a score of the pertinence of one or more items to a particular topic. In the depicted embodiment, 50% of the items pertain to a particular topic. A fourth score 410 may include a source quality score. In the depicted embodiment, a cited source “www.abc.com” received a source quality score of 1.0. A fifth score 412 may include a score for a quantity of curator-generated content. In the depicted embodiment, the curator generated 500 words. A sixth score 414 may include a number of comments. In the depicted embodiment, five comments were posted for the assessed curated content. A seventh score 416 may include a score for a number of views. In the depicted embodiment, the curated content was viewed 38 times. In this and other embodiments, the scores 404, 406, 408, 410, 412, 414, and 416 may be presented individually. In some alternative embodiments, one or more scores may be tallied, averaged, normalized, or otherwise combined or processed.

In this and other embodiments, the user engagement assessment result 402 includes one or more scores 418 and 420 that may be a result of assessment of curated content and/or comment data of a curation. An eighth score 418 may include a number of comments on other content with a similar topic area posted by a curator of the curated content. In the depicted embodiment, two comments were posted on other content with a similar topic area. A ninth score 420 may include a number of replies the curator posted in response to comments. In the depicted embodiment, three replies were posted by the curator. In this and other embodiments, the scores 418 and 420 may be presented individually. In some alternative embodiments, one or more scores may be tallied, averaged, normalized, or otherwise combined or processed.

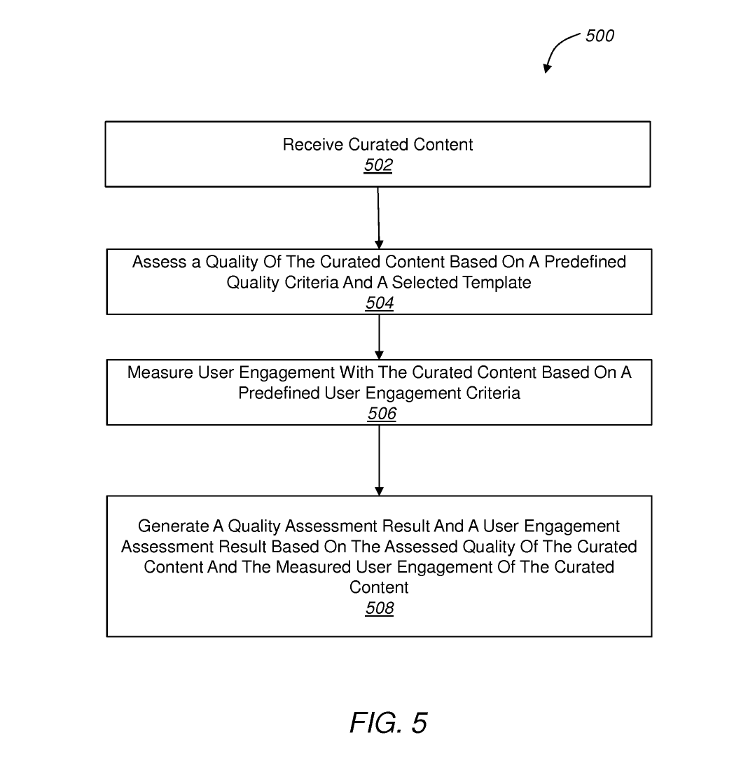

FIG. 5 is a flow diagram of an example method 500 of assessing curated content, in accordance with at least one embodiment described herein. The method 500 may be programmably performed in some embodiments by the system 106 described with reference to FIGS. 1-3. In some embodiments, the system 106 may include or may be communicatively coupled to a non-transitory computer-readable medium (e.g., the memory 222 of FIG. 2) having stored thereon programming code or instructions that are executable by a computing device to cause the computing device to perform the example method 500. Additionally or alternatively, the system 106 may include the processor 220 described above configured to execute computer instructions to cause a computing system to perform the method 500. Although illustrated as discrete blocks, various blocks may be divided into additional blocks, combined into fewer blocks, or eliminated, depending on the desired implementation.

The method 500 may begin at block 502. At block 502, curated content may be received. At block 504, a quality of the curated content may be assessed based on a predefined quality criteria and a selected template. In some embodiments, the selected template may include a content structure and a principal keyword list. Alternatively or additionally, the content structure may include a text pattern signal, which may include words and phrases indicative of a corresponding content structure. The words and phrases may be included in a dictionary and/or may be customizable.

In some embodiments, the principal keyword list may include one or more keywords. The keywords may be initially identified and included in a keyword candidate list. The keywords may be selected from the keyword candidate list for inclusion in the principal keyword list.

Assessing the quality of the curated content may include one or more steps or actions. In some embodiments, assessing the quality of the curated content may include determining whether the curated content meets a condition of the selected template. For example, in some embodiments, assessing the curated content may include determining whether the curated content contains the text pattern signal specified by the content structure. When the curated content contains the text pattern signal, assessing the quality of the curated content may also include calculating a hit ratio between the words and phrases included in the text pattern signal and terms included in the curated content. In these and other embodiments assessing the quality of the curated content may also include identifying terms included in the curated content that are included in the principal keyword list.

Additionally or alternatively, assessing the quality of the curated content may include one or more of: checking whether items of the curated content pertain to a particular topic; evaluating a source quality of items of the curated content; counting a number of comments associated with the curated content; counting a number of views of the curated content; and calculating a quantity of curator-generated content included in the curated content. In some embodiments calculating the quantity of curator-generated content may include identifying differences between cited original content and the curated content and totaling a number of words edited from the cited original content.

At block 506, user engagement with the curated content may be measured based on a predefined user engagement criteria. Measuring the user engagement may include analyzing whether a curator of the curated content commented on other content in a similar topic area. In addition, measuring the user engagement may include determining whether a curator of the curated content replied to a comment on the curated content.

At block 508, a quality assessment result and a user engagement assessment result may be generated based on the assessed quality of the curated content and the measured user engagement of the curated content.

One skilled in the art will appreciate that, for this and other procedures and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the disclosed embodiments. For instance, the method 500 may include receiving a teaching material related to an assignment. Based on the teaching material a keyword candidate list may be generated. Input effective to select keywords from the keyword candidate list may be received and a principal keyword list may be generated including the selected keywords.

Alternatively or additionally, the method 500 may include receiving a selected content structure type according to the assignment. In these and other embodiments, the selected content structure type may be included in the selected template and may include a customizable text pattern signal.

The embodiments described herein may include the use of a special purpose or general purpose computer including various computer hardware or software modules, as discussed in greater detail below.

Embodiments described herein may be implemented using computer-readable media for carrying or having computer-executable instructions or data structures stored thereon. Such computer-readable media may be any available media that may be accessed by a general purpose or special purpose computer. By way of example, and not limitation, such computer-readable media may include tangible computer-readable storage media including RAM, ROM, EEPROM, CD-ROM or other optical disk storage, magnetic disk storage or other magnetic storage devices, or any other storage medium which may be used to carry or store desired program code in the form of computer-executable instructions or data structures and which may be accessed by a general purpose or special purpose computer. Combinations of the above may also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” may refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present invention have been described in detail, it should be understood that the various changes, substitutions, and alterations could be made hereto without departing from the spirit and scope of the invention.

What is claimed is:

1. A method of assessing curated content, the method comprising:
receiving curated content;
assessing a quality of the curated content based on a predefined quality criteria and a selected template;
measuring user engagement with the curated content based on a predefined user engagement criteria; and
generating a quality assessment result and a user engagement assessment result based on the assessed quality of the curated content and the measured user engagement of the curated content.

2. The method of claim 1, wherein the selected template includes a content structure and a principal keyword list.

3. The method of claim 2, wherein the assessing includes determining whether the curated content contains a text pattern signal specified by the content structure.

4. The method of claim 3, wherein the assessing further includes calculating a hit ratio between words and phrases included in the text pattern signal and terms included in the curated content.

5. The method of claim 2, wherein the assessing includes identifying terms included in the curated content that are included in the principal keyword list.

6. The method of claim 1, wherein the assessing includes one or more of:
determining whether the curated content meets a condition of the selected template;
checking whether items of the curated content pertain to a particular topic;
evaluating a source quality of items of the curated content;
calculating a quantity of curator-generated content included in the curated content;
counting a number of comments associated with the curated content; and
counting a number of views of the curated content.

7. The method of claim 6, wherein the calculating includes:
identifying differences between a cited piece of web content and the curated content; and
totaling a number of words edited from the cited piece of web content.

8. The method of claim 1, wherein the measuring includes:
analyzing whether a curator of the curated content has commented on other content in a similar topic area; and
determining whether a curator of the curated content replied to a comment on the curated content.

9. The method of claim 1, further comprising:
receiving a teaching material related to an assignment;
generating a keyword candidate list based on the teaching material;
receiving input effective to select keywords from the keyword candidate list; and
generating a principal keyword list including the selected keywords.

10. The method of claim 1, further comprising receiving a selected content structure type according to an assignment, wherein the selected content structure type is included in the selected template and includes a customizable text pattern signal.

11. A non-transitory computer-readable medium having encoded thereon programming code executable by a processing device to perform the method of claim 1.

12. A curated content assessment system comprising:
a processor;
a non-transitory computer-readable storage medium communicatively coupled to the processor and having computer-executable instructions stored thereon that are executable by the processor to perform operations comprising:
receiving curated content;
assessing a quality of the curated content based on a predefined quality criteria and a selected template;
measuring user engagement with the curated content based on a predefined user engagement criteria; and
generating a quality assessment result and a user engagement assessment result based on the assessed quality of the curated content and the measured user engagement of the curated content.

13. The system of claim 12, wherein the selected template includes a content structure and a principal keyword list.

14. The system of claim 12, wherein the assessing includes:
determining whether the curated content contains a text pattern signal specified by the content structure; and
calculating a hit ratio between words and phrases included in the text pattern signal and terms included in the curated content.

15. The system of claim 12, wherein the assessing includes identifying terms included in the curated content that are included in the principal keyword list.

16. The system of claim 12, wherein the assessing includes one or more of:
determining whether the curated content meets a condition of the selected template;
checking whether items of the curated content pertain to a particular topic;
evaluating a source quality of items of the curated content;
calculating a quantity of curator-generated content included in the curated content;
counting a number of comments associated with the curated content; and
counting a number of views of the curated content.

17. The system of claim 16, wherein the calculating includes:
identifying differences between a cited piece of web content and the curated content; and
totaling a number of words edited from the cited piece of web content.

18. The system of claim 12, wherein the measuring includes:
analyzing whether a curator of the curated content has commented on other content in a similar topic area; and
determining whether a curator of the curated content replied to a comment on the curated content.

19. The system of claim 12, wherein the operations further comprise:
receiving a teaching material related to an assignment;
generating a keyword candidate list based on the teaching material;
receiving input effective to select keywords from the keyword candidate list; and
generating a principal keyword list including the selected keywords.

20. The system of claim 12, wherein the operations further comprise receiving a selected content structure type according to an assignment, wherein the selected content structure type is included in the selected template and includes a customizable text pattern signal.
